(19) United States
(12) Patent Application Publication
(10) Pub. No.: US 2025/0098600 A1
(43) Pub. Date: Mar. 27, 2025

(54) A SYSTEM FOR ENHANCING RAIN IRRIGATION WATER FOR GROWING PLANTS BY RAIN DIVERSION SURFACES

(71) Applicant: TRIGO SOLAR LTD, Kibbutz Ga’ash (IL)

(72) Inventors: Israel OHANA, Haifa (IL); Doron RETTER, Givat Shapira (IL); Avi ELKAYAM, Sde' Hemed (IL)

(21) Appl. No.: 18/683,405

(22) PCT Filed: Aug. 10, 2022
(86) PCT No.: PCT/IL2022/050873

§ 371 Date: Feb. 13, 2024

Related U.S. Application Data
(60) Provisional application No. 63/233,335, filed on Aug. 16, 2021.

(51) Int. Cl. A01G 9/14; A01G 9/24; A01G 25/00

(52) U.S. Cl. CPC A01G 9/1476; A01G 9/243; A01G 25/00

(57) ABSTRACT

The invention is a system for enhancing rain irrigation water of agricultural areas by rain diversion surfaces. The system is composed of at least two longitudinally connected rain diversion structure units (RDS-s) that divert rain water to an area adjacent to the RDS-s. Each RDS unit is composed of at least one supporting bar which connects a roof structure. The roof structure is composed of a relatively smooth and slanted rain diverting surfaces which are composed of rigid plates. At least two longitudinally connected RDS units are positioned in an approximate parallel configuration in a manner that divides an agricultural used area/land into alternating strips of RDS-s and plants growing. Rain water falls on the RDS-s strips and is diverted to the plant growing strips. The diverted rain water adds to the rain water that falls simultaneously on the plant growing strips. Optionally, the slanted rain diverting sheet-plates of the RDS-s are made of photo voltaic solar modules and serve for the dual purpose of rain water diverting and solar energy harvesting.

### FIELD OF THE INVENTION

The present invention relates to a system for enhancing the rain irrigation water of agricultural areas by rain diversion surfaces. More specifically, the system of the invention is composed of rain diversion structures (RDS-s) positioned in an approximate parallel configuration in a manner that divides an agricultural used area/land into alternating strips of RDS-s and growing plants. Rain water from the RDS-s strips is diverted and added to the rain water that falls on the plant growing strips. Optionally, the RDS-s serve for the dual purpose of rain water diverting and solar energy harvesting, utilizing the rain diverting surfaces as solar energy harvesting panels.

### BACKGROUND OF THE INVENTION

Rain-fed crops, such as wheat and maize, account for a substantial portion of the world's staple food. However, climate change, deforestation, and desertification of agricultural land, lead to reduction in precipitation which leads to a reduced yield per unit area. As a rule of thumb, yield of rain-fed crops, especially in the range of 250-300 mm, is proportional to the amount of water that is available to the plant, however there is a minimum amount of precipitation that is required for a successful growth of agricultural plants. Thus, during drought years the plants may not grow at all and the yield may be zero. The common solution for lack of precipitation is irrigation, which is an artificial process that provides controlled amounts of water to the plants in a defined schedule. For example, in certain countries, rainwater may be collected and stored in tanks or in artificial ponds, to be used later for irrigation.

Irrigation is very useful and can provide superior agricultural results. Irrigation systems can be used in a specific schedule that best matches the need of the plants. However, irrigation systems need storage capacity that matches the irrigation schedule and available water distribution systems to deliver the water from the storage facility to the plant cultivation area. Commodities such as wheat and maize can rarely bear the additional investment required for water storage and irrigation systems, especially in large-scale growing areas, where the distance between the water reservoirs and the planting area is in many cases significant, thus, the building of a reservoir and pumping of the water requires expensive infra structure and expensive energy input. For the listed reasons, a substantial portion of staple food is grown using only rain water.

The current invention provides an economical solution for increasing the yield while reducing the cost of growing rain-fed crops, specifically in areas where the amount of the rain water are not sufficient for maximum potential yield of a specific crop. The invention enables, by using rain-diversion surfaces, the simultaneous diversion of rain water from portions of the land to other portions. The term “enhancement” refers in the text as substantially increasing or amplifying the amount of water available for irrigation. In the text, the rain diversion surfaces are part of rain diversion structure configurations, referred to as RDS-s. As such, the planting and cultivation area is smaller, but the yield per area unit is higher, typically, in the same ratio. For example, instead of growing wheat on one full hectare of land, with rain precipitation of 200 mm/annum, the current invention enables a farmer to grow wheat on several strips with a total area of only half an hectare, and divert the same amount of rainfall on half an hectare of rain from the RDS-s to the other half hectare, to the cultivated area. The cultivated area will receive a total of 400 mm/annum and the yield per area-unit will be higher. As the farmer will cultivate only half of the area, the farmer will save half of the variable expenses associated with the cultivation. Since the yield will be higher per area unit (e.g. almost twice), the internal rate of return of the farmer's investment will increase. In cases where the RDS-s also produce solar energy, the farmer may benefit from another source of income.

Since the current invention increases the actual amount of water received per area unit on which a given rain precipitation is obtained, it provides increased protection against drought years, as it reduces the chance that the amount of precipitation will be lower than the threshold required for plants growth. For example, assuming that a plant will need a minimum of 150 mm of rain, and assuming that in a certain year the precipitation is only 100 mm, and assuming that the diverting area and the plant growing area are equal, the current invention will increase the amount of rain per area unit, to 200 mm of rain, which is above the threshold.

An additional factor that has to be considered in calculating the costs of the water storage facilities as well as the use of water distribution systems in growing agricultural crops is the cost of energy and the infrastructure associated with the cultivation activities. The harvesting of solar energy, which is gaining popularity with the demand to reduce air pollution and the increase in the efficiency of solar panel technologies, requires large sun exposure areas. The present invention presents the option of the use of the mentioned rain-diversion surfaces also as solar panels for sun energy harvesting. The integration of sun energy harvesting solar panels with rain water diversion surfaces requires the alignment of the rain diversion surfaces/solar panels with the path of the sun in the sky and enables dual use of the land for growing crops and harvesting sun energy. The sun energy harvested by the rain-diversion solar panels may (also) be commercialized for use not related to the crop cultivation.

The idea of collecting rain water and later use it for irrigation is not new and is commonly associated with the use of the surfaces of solar panel modules, as described in the publications: CN108770664 (Lili et al.), CN10984491 (Wenjing et al.), CN208191704 (Daozhi et al.) and Fr2963720 (Cartrier). In the present invention the combination between rain water plants irrigation and the use of the surfaces of solar panel modules for rain water collection is substantially more efficient than previously disclosed.

The system described in the present invention is simple to construct and is primarily aimed at diverting rain water for agricultural usage. The possible use of the rain diverting surfaces of the system for solar energy harvesting is of secondary consideration. The invention is a system that utilizes rain diversion surfaces for irrigating agricultural crops, grown in locations where water is scarce, in a manner significantly more efficient than was previously disclosed.

### SUMMARY OF THE INVENTION

The present invention is a system for enhancing the rain irrigation of agricultural areas by rain diverting surfaces. The system is composed of elongated structure units in which each unit is composed of at least one supporting bar, typically four or more bars, that is/are fixated and stabilized in the ground and have connected to its upright upper section, a roof rain diverting surface structure. The support bars and the roof structure is referred to in the text as a “Rain Diverting Structure” (RDS) unit. The roof structure is composed of a relatively smooth sheet-plates forming rain diverting surfaces. Each RDS can function as a single entity but, typically, two or more RDS units are connected to each other by their rain diverting surfaces, forming a RDS-s longitudinal columns, referred in the text as “RDS-s strips”.

RDS-s strips are typically positioned in an approximate parallel configuration, with the area/land to be irrigated located between the RDS strips. The width of the RDS strips correlates to the rain diversion area, while the width of the area between the RDS-s strips, referred to as “planting strips” or interchangeably, as “plant growing” strips, correlates to the agriculturally cultivated (plants growing) area. The ratio between the width of the RDS-s strips and the width of the planting-strips determines the amount of rain amplification. For example, if both widths are equal, the amount of available rain per area unit will double. Practically, the width of the strips shall be determined by the size of the agricultural machinery used, such as the width of the combine. The term “approximate parallel configuration” for the RDS-s strips refers an angle between the strips that is typically, but not limited, to 0 and 20 degrees. Since the length of the strips can be substantial (tens of hundreds of meter) and with different topographic layouts, the angle between the approximate parallel strips may vary along the path of the strips.

Three configurational embodiments are presented for the structural configuration of the system's rain diverting surfaces: 1) pairs of diverting surfaces positioned in configuration that form longitudinal inverted (up-side-down), “v” or “u” roof structures over the support bars. 2) diverting surfaces positioned in a configuration that forms longitudinally and slanted rain diversion surface area roof structures over the support bars. 3) pairs of surfaces diverters positioned in configuration that form upright “v” or “u” roof structures over the support bars.

Optionally, the rain diverting surfaces of the RDS-s are also solar energy harvesting surfaces of photo-voltaic modules, thus, integrating in the RDS-s both rain harvesting with solar energy harvesting.

Optionally, the rain diverting surfaces of the RDS-s are also be solar energy harvesting surfaces of sun tracking photo-voltaic modules thus, integrating in the RDS-s the feature of both rain harvesting with maximizing the solar energy harvesting.

When the RDS-s are composed of rain diversity surfaces that also serve for solar energy harvesting, the RDS-columns are preferably positioned in approximately north-south direction, with the roof structures of the RDS-s facing the sun in the course of the day thus allowing for better land utilization photovoltaic cells

Optionally, to maximize the agricultural crop yield obtained from the plant growing strips the plant growing strips are positioned in an approximately north to south configuration to minimize the shading of the plants. The positioning of the growing strips, and with them the RDS-s strips, in an approximately north to south configuration is crucial for obtaining maximum energy harvesting when the rain diversity surfaces of the RDS-s also serve for solar energy harvesting.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a prior art schematic illustration, presenting graphically the relationship between precipitation and yield of rain-fed crops.

FIG. 2 is a schematic illustration, viewed from above, of a land area with alternating strips of planting area and rain-diversion structures (RDS-s) strips.

FIG. 3 is schematic, viewed from the side, of the system of the invention in the process of diverting rain water to planting strips using inverted “v” configuration rain diversion surfaces in the RDS-s.

FIG. 4 is an isometric schematic illustration, seen from above and side, of the system of the invention having inverted “v” configuration rain diversion surfaces in the RDS-s, as shown in FIG. 3

FIG. 5 is an isometric illustration, viewed from above and side, of a water gutter running along the edge of an inverted “v” configuration rain diversion surface of an RDS.

FIG. 6 is schematic, viewed from the side, of the system of the invention in the process of diverting rain water to planting strips, using slanted rain diversion surfaces in the RDS-s.

FIG. 7 is an isometric schematic illustration, seen from above and side, of the system of the invention having upright “v” rain diversion surfaces in the RDS-s.

FIG. 8 is an isometric schematic illustration of a single axis sun tracking photo-voltaic modules with the surface of the modules serving (simultaneously) as both rain diverting and sun energy harvesting surface.

### DETAILED DESCRIPTION OF PREFERRED EMBODIMENTS

The present invention is a system for enhancing the rain irrigation of agricultural areas by rain diverting surfaces. The system is composed of elongated structure units in which each unit is composed of at least one supporting bar, typically four or more bars, that is/are fixated and stabilized in the ground and have connected to its upright upper section, a roof rain diverting surface structure. The support bars and the roof structure is referred to in the text as a “Rain Diverting Structure” unit (RDS) (36). The roof structure is composed of a relatively smooth rain diverting sheet-plates (42) forming rain diverting surfaces (43). The support bars are made of a rigid material, such, but not limited to, plastic, metallic materials or wood, that can endure harsh environmental conditions for long time periods (many months and years). The rain diverting sheet-plates (42) are made of, but not limited to rigid plastic or metallic material(s), typically having a thickness of, but not limited to, 0.5 to 5 cm. The smooth sheet-plates (42) of the rain diverting surfaces (43) of each RDS can be structured as a single entity plate or optionally, be composed of two or more plate units connected together in a water tight connection. The spatial structure of the rain diverting sheet-plates (42) is typically flat plates, but can be constructed in other configurations that enable rain water to flow freely on the surface of rain diverting sheet-plates surfaces when the plates are slanted. Each RDS unit can function as a single entity but, typically, two or more RDS units are connected to each other by their rain diverting surfaces, forming a RDS-s longitudinal columns, referred in the text as “RDS-s strips” (30).

Three embodiments of the configuration of the rain diverting surfaces are presented: 1) an inverted “v” or inverted “u” configuration (10), 2) a slanted surface-plates configuration (50), 3) an upright “v” or upright “u” configuration (60). In the text, the descriptions given for the inverted “v” and the upright “v” configurations are (also) valid for rain diverting surfaces in an inverted “u” and the upright “u” configurations. The slant of the water diverting surfaces (43) in the three embodiments is in an angle-configuration so as to have the rain water (33) stream freely and with ease to the edge of the diverting surfaces. The angle of the slant of the rain diverting surfaces relatively to the horizontal ground is, but not limited to 3 to 50 degrees, typically being 5 to 10 degrees.

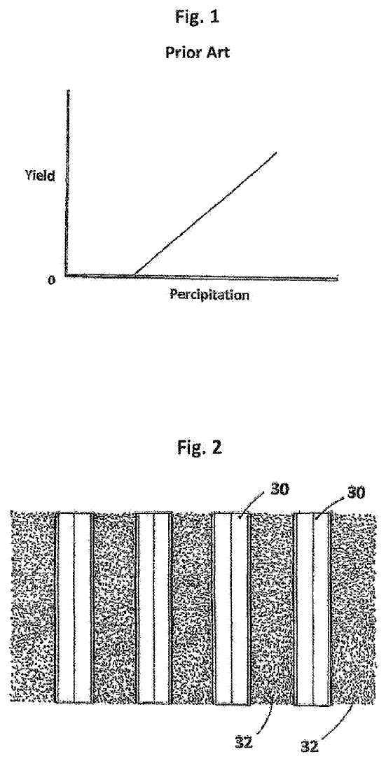

The correlation of yield of crops, such as wheat and maize, to irrigation is schematically shown in the prior art FIG. 1. As seen in the figure, a minimal amount of water is required to initiate the growth of the crops. After initiation, the crop's yield is proportional to the amount of available water for the crop's-irrigation. In locations where there is a regular shortage of rain fall, the ability to concentrate the limited rain that falls over an entire designated area to irrigate (only) a portion of the total designated area with the entire amount of water can be crucial for the growth ability of crops in the location. The ability to divert the rain water from the entire area to the designated plants growing area must be economically suitable so as to be of practical use for the growers of the crops. The system of the invention addresses the issue of rain water concentration for irrigation of crops using a reliable and inexpensive technology.

As previously stated, each RDS strip (30) can be structured as a single entity composed of a single elongated RDS unit, but, typically, composed of two or more adjacent RDS unit structures longitudinally close-to-each-other positioned and having their rain diverting surfaces connected, thus, forming a RDS-s longitudinal column. Connection of the rain diverting surfaces (43) are water-tight (no leakage) connections. Optionally, the rain diverting surfaces (43) the close-to-each-other RDS-s form a continuous surfaces (thus eliminating the need of a connection between the diverting surfaces (43)).

The system for enhancing the rain irrigation of agricultural areas by rain diverting surfaces is based on approximately parallel positioned RDS-s strips (30) from which rain water is used for irrigation the plant growing strips (32) located between the RDS-s strips. The rain water that falls on rain diverting surfaces is added to the rain that falls simultaneously on the plant growing strips (32) The width of the RDS-s strips correlates to the diversion area, while the width of the adjacent, parallel strips, correlates to the plants planting and growing area.

FIG. 2 illustrates the parallel alternating strips: the RDS-s strips designated (30), the planting and plant growing strips, designated (32).

Presently the first embodiment of the rain diverting surfaces system (10), using inverted “v” configuration rain diverting surfaces (43) is presented.

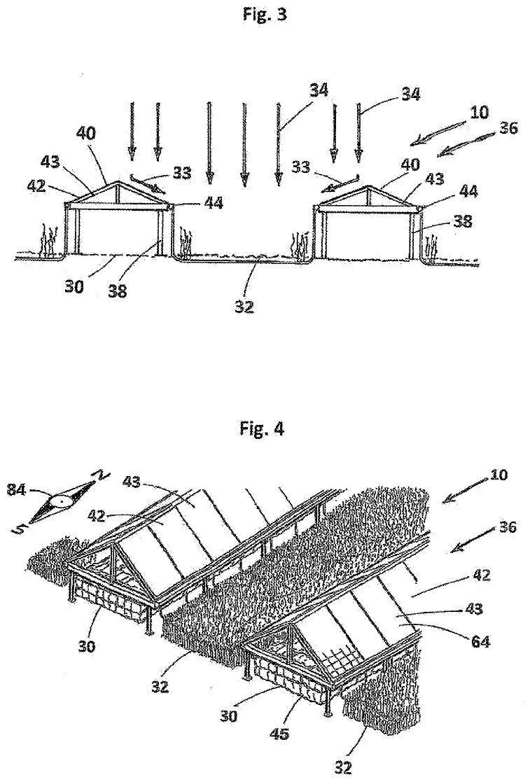

FIG. 3 is an illustration of the system of the invention (10) in the process of diverting rain water to planting strips with the diverting surfaces in an inverted “v” configuration. The rain coming down is designated by arrows (34). Each rain-diverting structure (RDS) (36) in the system (10) is composed of vertically positioned support-bars (38) made of a rigid and strong material such as, but not limited to, metallic material(s), plastic or wood. The support-bars (38) connect at their upper portion to a longitudinal inverted “v” shaped roof structure (40). Typically, the outwards facing surfaces of the inverted “v” shaped roof structure (40) are made of two surface plates (42) connected at the tip of the inverted “v”. Optionally, the width of the two outwards two facing surfaces of the upside-down, “v” shaped structure do not necessarily have the same length.

The description “strong” and “rigid” in describing the bars (38) and plates (42) of the RDS-s (36) in the text refers to the ability to sustain intact for months and years in rough environmental conditions and physical pressures. The term “smooth” in the text refers to the ability of water to slide with case on the plates (42) of the RDS-s (40). The slanted outwards plate surfaces (42) of the inverted “v” form rain diverting surfaces (43) that run along the entire length of each RDS (36). The configuration of the angle of the slant of the rain diverting surfaces is such as to enable the streaming with case of water. When rain falls (34) it falls both on the planted planting strips (32) and on the area of RDS-s strips (30). Rain falling (34) on the diverting surfaces (43) of each RDS (36) is directed to the adjacent planting strip by the use of the two slanted rain water diversion surfaces (43). The rain water running on the diverting surfaces is designated: (33). The height of the inverted “v” shaped roof structure (40) is elevated above the planting strip (32) surface in order to provide gravitational pressure in the water distribution system.

FIG. 4 shows an isometric schematic illustration seen from above and side of alternating strips of planting strips (32) and RDS-s (36) strips (30). The illustration shows the components of the system (10): the rain diversion surfaces (43), the support-bars of the RDS-s (38) and hay (49) stored under the rain diversion surfaces (43). A directional indicator north to south, designated (84), indicates the preferable directional positioning of the RDS-s strips (30) and plant growing strips (32), approximately (plus minus 40 degrees) north-to-south, so as to minimize the shading of the growing plants.

The structure of RDS-s (36), shown in FIG. 4, enables the dry storage area under the cover of the diversion surfaces ((40) or (41). The storage area can be used for storage of hay (49), thus reducing hay costs since the farmer saves storage cost and transportation cost from the field to a temporary storage area away from the field.

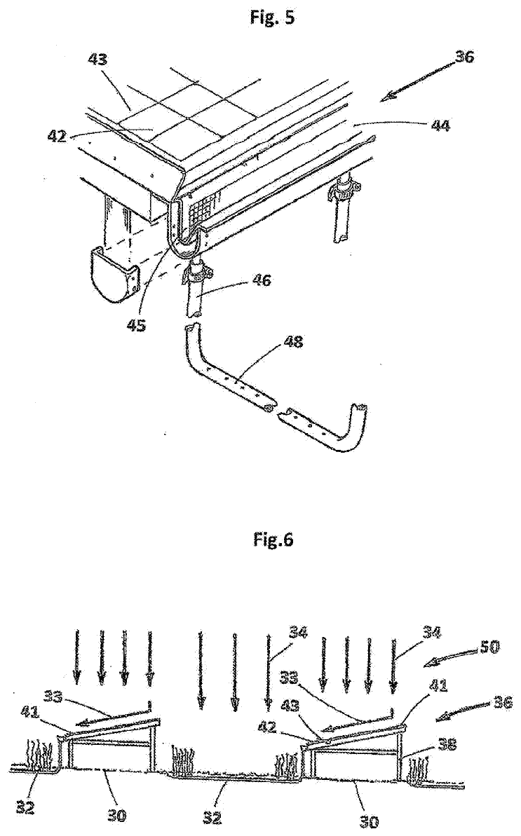

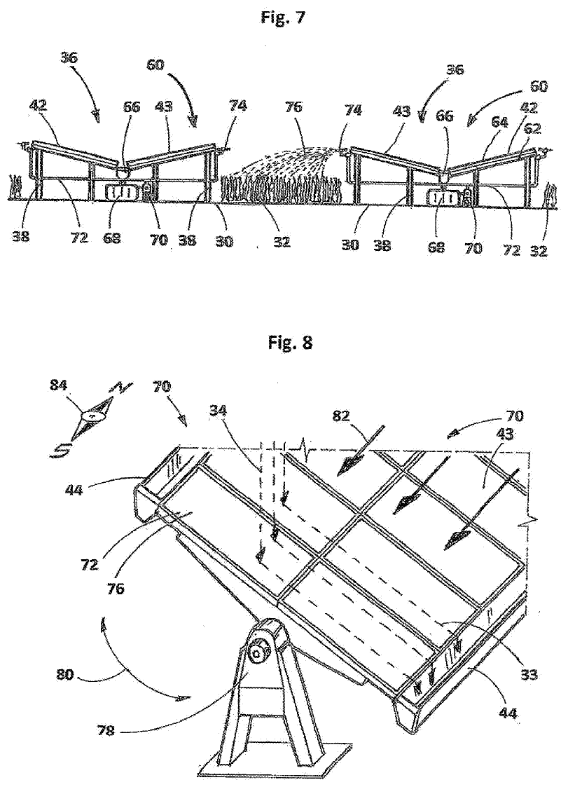

Optionally, shown in FIG. 5, a RDS (36) that includes a water gutter (44) along the free edge (45) of the rain diversion surfaces (43). The gutter (44) concentrates the rain water into a watering hose (46). The pressure of the water inside the hose is set by the height of the hose above the planting surface. In a typical setup, the height of the gutter would be approximately 1 meter above the planting area, and the pressure of the hose resting on the planting area will be approximately 0.1 bar.

The location, size, and number of holes (48) in the watering hose (46), which acts as a water trickling system, will determine the flow rate of water from the gutter (44), and the water distribution pattern on the planting area. Since the yield of crops, such as wheat is proportional to the amount of water it receives, a uniform distribution pattern is desired but not mandatory. The number, location, and size of the holes will depend on the type of soil, the anticipated precipitation time distribution, the width of the planting area, the diameter of the watering hose, and the height of the gutter above the planting area.

Optionally, the water from the gutter (44) will be diverted to a storage vessel (not shown in the figures) and will be used for irrigation of the cultivation strip using agricultural water distributing systems such as .sprinklers or a trickling system deployed by using pumps. The option of storage of rain water from the RDS-s strips in vessels, to be used for irrigation by deploying pumps, described for the first embodiment is also valid for the second and third described embodiment.

Optionally, the managing of the time, the duration and watering-volume of the cultivation strips is done by operating the pump(s) connected to the storage vessels by electronic means, thus enabling the farmer to decide on the best use of the diverted rain water for the plant growing strips

The description of the support-bars (38) that connect at their upper portion to the roof rain diverting roof structures (40) given for the first embodiment (10) is also valid for the second embodiment (50) and third embodiment (60) of the rain diverting system of the invention, in describing the connection of the roof rain diverting roof structures (41) and (62) respectively, to the support bars (38).

The description of the smooth surface-plates (42) that form the rain diverting surfaces (43), provided for the first embodiment of the rain diverting system (10) is also valid for the second embodiment (50) and third embodiment (60) of the rain diverting system of the invention.

Presently the second embodiment (50) of the rain diverting system, using a slanted plates (42) configuration, is presented.

An alternative to the inverted “v” shaped roof structure of the RDS-s (36) is the use of a slanted smooth surface-plate or (several connected plates) (42) in roof structure (41) in the system (50), as illustrated schematically in FIG. 6. As shown in the figure, the system is in the process of diverting rain water (33) to planting strips (32) by the slanted rain water diverting surfaces (43). The diverting surfaces (43) of the embodiment have a slanting angle between 10 and 40 degrees relatively to the ground-horizontal configuration. In the text the slant angle is referred to as: “in a slanted, approximately horizontal, configuration”. The slanted rain water diverting surfaces (43) roof structures (41) optionally connect in the margin of the lower portion of the slanted water diverting surfaces to a water gutter (44) as illustrated in FIG. 5 and previously explained in the text.

Presently the third embodiment of the rain diverting surfaces system (60) using an upright “v” structure configuration (or, alternatively, upright “u structure configuration) of the rain diverting surfaces (43) is presented.

Each rain-diverting structure (RDS) (36) in the system (60) is composed of vertically positioned support-bars (38). The support-bars (38) connect at their upper portion to a longitudinal an upright “v” shaped roof structure (62). Typically, the two facing surfaces of the upright “v” shaped roof structure (62) are made of two strong and relatively smooth surface plates (42) that form water diverting surfaces (43). The two slanted surface-plates (42) upright “v” shaped roof structure (62) are not connect at the base of the “v” and have between them, connected to the gap between the plates (42), a collection channel (66) that collects rain water that drops on the external, sky directed, inner sides of the upright “v” shaped roof structure (62) on the water diverting surfaces (43). The water enters the channel (66) and is directed gravitationally to a collection vessel (68) positioned under the upright “v” shaped roof structure (62) between support bars (38). The collection vessel (68) is a water holding container, made of, but not limited to, a metallic or plastic material. The water collected and stored in the collection vessel (68) is distributed to the planting strips (32) adjacent to the RDS strips (30).

The distribution of the stored water in the collection vessel (68) is typically done by pumping the water by a pump (70) that pumps/pushes the water via tubes (72) that run under the upright “v” shaped roof structure (62) to sprinklers (74) that spray the water (76) on the plants in the planting strips (32). Alternatively, another, water distribution system is deployed, such as a trickling system. The pumping and water distribution process can be done during the rain fall or with a delay as was previously described.

Optionally, the rain water diverting surfaces (43) of the RDS-s (36), described in the three described embodiments ((10), (50) and (60)) can also function simultaneously as photo-voltaic modules. In order to function with maximum efficiently as photo-voltaic modules, the RDS-s strips (30) and planting strips (32) are to be positioned in an approximate north-south directional layout, providing a 180 degrees (plus-minus 40 degrees) facing east-west directions of the combined diverting surfaces (43) and photo-voltaic modules. By combining the functioning of the diverting surfaces (43) and photo-voltaic modules in the RDS-s (36) the economic utilization of the land is substantially increased.

In order to make use of the diverting surfaces as photo-voltaic modules the appropriate (not shown in the figures) infra structure for electrical generation, utilization and electricity transferring has to be added to the RDS-s (36).

Optionally, rain diverting surfaces (43) that also function as photo-voltaic modules can substantially increase their sun energy harvesting by operating as single axis sun tracking photo-voltaic modules (70). Each sun tracking photo-voltaic module (70) is composed of a sun harvesting surface (72) and a surface mobility mechanism (78). The surfaces of the sun tracking photo-voltaic modules (70) change the tilting angle of the combined rain diverting surfaces (43) and solar energy harvesting photo-voltaic surfaces (72) during the course of the day so as to have the solar energy solar harvesting surfaces as long as possible and as much as possible in an angle that directly exposes the surfaces to the sun in the sky. The tilting angles of the tracking photo-voltaic surfaces (72) is configured so as maximize the solar energy harvesting when the sky is clear and maximize the rain water harvesting when the sky is over casted and rain is expected.

FIG. 8 an isometric schematic illustration of a single axis sun tracking photo-voltaic modules (70) with the surface of the modules serving in combination both as a rain diverting surface (43) and a photo-voltaic modules sun energy harvesting surface (72). The surface serving both functions is designated (76).

Preferably, but not limited to, the utilization of the single axis sun tracking photo-voltaic modules (70) as part of an RDS (36) is using the second previously described embodiment of the rain diverting system (50) configuration, shown in FIG. 6. The slanted sheet-plates (42) configuration in FIG. 6 are replaced by the surface (76), shown in FIG. 8 with the single axis sun tracking photo-voltaic modules (70) connected as a roof structure to the upper portion of support-bars (38). In FIG. 8, the sun tracking mobility mechanism of the surface (76) is designated (78) and the course of the movement, in tracking the sun is designated in the double headed arrow (80). In the FIG. 8 the sun rays hitting surface (76) are designated (82), the rain water dropping on surface (76) is designated (34) and the rain water running on the diverting surfaces is designated: (33). A water collecting gutter (44), illustrated in FIG. 5, runs along the two free edges of surface (76). A directional indicator north to south, designated (84) indicates that the RDS-s strips (30) with the RDS-s (38) with single axis sun tracking photo-voltaic modules (70) are positioned in an approximate north to south configuration, so as to enable the maximum sun energy harvesting be the photo-voltaic modules (70).

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

I claim:

1) A system for enhancing irrigation by rain water of plant growing areas by the use of rain diverting surfaces,
said system comprising at least one rain diverting structure (RDS) and a plant growing area adjacent to said RDS,
said RDS comprises:
at least one vertical support-bar,
a rain diverting surface roof structure,
said diverting surface roof structure comprises of at least one smooth rain diverting surface plate,
said rain diverting surface roof structure connects to the upper portion of said vertical support bars,
said rain diverting smooth surface plates in said roof structure are configured in a slanted angle so as to enable rain water that falls on said rain diverting smooth surface plates to stream freely and with ease to the edge of said rain diverting surface,
said rain water from said edge of said diverting smooth surface plates are diverted to said plant growing area and are added to the rain that falls on said plant growing area for irrigation.

2) The slanted angle of rain diverting smooth surface plates of claim 1, whereby, said slanted angle of said rain diverting smooth surface plates is between 3 and 50 degrees relatively to the horizontal ground.

3) The vertical support-bars of claim 1, whereby, said vertical support-bars are made of an environmental conditions enduring, rigid material.

4) The rain diverting smooth surface plates of claim 1, whereby, said rain diverting smooth surface plates are made of a rigid material.

5) The rain diverting smooth surface plates of claim 4, whereby, said rain diverting smooth surface plates are made of a plastic material.

6) The rain diverting smooth surface plates of claim 4 whereby, said rain diverting smooth surface plates are made of a metallic material.

7) The rain diverting smooth surface plates of claim 4, whereby, said rain diverting smooth surface plates are made of a glass material.

8) The RDS of claim 1, whereby, at least two RDS-s are longitudinally connected by the connection of their rain diverting surfaces, forming an elongated RDS-s strip.

9) The elongated RDS-s strip of claim 8, whereby, at least two elongated RDS-s strips are positioned in an approximate parallel configuration, forming a plant growing strip in the area between the said RDS-s strips.

10) The plant growing strips of claim 9, whereby, said plant growing strips are positioned in an approximately north to south configuration.

11) The rain diverting surface roof structure of said RDS of claim 1 whereby, the roof structure comprises said rain diverting surface roof structures configured in a “v” shaped configuration.

12) The rain diverting surface roof structure of said RDS of claim 1 whereby, the roof structure comprises said rain diverting surface roof structures configured in a “u” shaped configuration.

13) The rain diverting surface roof structure of said RDS of claim 1 whereby, the roof structure comprises said rain diverting surface roof structures configured in an inverted “v” shaped configuration.

14) The rain diverting surface roof structure of said RDS of claim 1 whereby, the roof structure comprises said rain diverting surface roof structures configured in an inverted “u” shaped configuration.

15) The rain diverting surface roof structure of said RDS of claim 1 whereby, the roof structure comprises said rain diverting surface roof structures configured in a slanted, approximately horizontal, configuration.

16) The connected slanted rain diverting surfaces of claim 1, whereby said rain diverting surfaces have along their lower edge, a gutter for water capturing.

17) The captured water of claim 16, whereby, said water is used for irrigation using agricultural water distributing systems.

18) The rain diverting surfaces of claim 1 whereby, said rain diverting surfaces are photo-voltaic modules for generating solar electricity.

19) The rain diverting surfaces which are photo-voltaic modules for generating solar electricity of claim 19, whereby, said photo-voltaic modules are single axe sun tracking photo-voltaic modules.
